(19) United States
(12) Patent Application Publication
(10) Pub. No.: US 2024/0428278 A1
(43) Pub. Date: Dec. 26, 2024

(54) APPARATUS AND METHOD FOR PROVIDING COSMETICS TREND PREDICTION SERVICE

(71) Applicant: LoudLabs Inc., Seoul (KR)

(72) Inventor: Hyun Jung LEE, Seoul (KR)

(73) Assignee: LoudLabs Inc., Seoul (KR)

(21) Appl. No.: 18/766,064

(22) Filed: Jul. 8, 2024

Related U.S. Application Data
(63) Continuation of application No. PCT/KR2023/000225, filed on Jan. 5, 2023.

(30) Foreign Application Priority Data
Jan. 6, 2022 (KR) 10-2022-0002117

(51) Int. Cl. G06Q 30/0202

(52) U.S. Cl. CPC G06Q 30/0202

(57) ABSTRACT

Disclosed is an apparatus for providing a cosmetics trend prediction service, and the apparatus is connected to a user terminal and an external server to receive cosmetics-related product data and cosmetics-related social data, process and process the cosmetics-related product data and the cosmetics-related social data, classify the processed cosmetics-related product data and the cosmetics-related social data to create the corresponding tag, extract a keyword from the tag, extract a keyword from the cosmetics-related product data and the cosmetics-related social data, and analyze and predict a cosmetics trend based on the extracted keyword.

### CROSS-REFERENCE TO RELATED APPLICATIONS

This application is a Continuation Application of International Application No. PCT/KR2023/000225, filed Jan. 5, 2023, which claim for priority under 35 U.S.C. § 119 is made to Korean Patent Application No. 10-2022-0002117 on Jan. 6, 2022. The disclosures of the above-listed applications are hereby incorporated by reference herein in their entirety.

### BACKGROUND

### 1. Technical Field

The present disclosure relates to an apparatus for providing a cosmetics trend prediction service, and more specifically, to an apparatus and method for providing a cosmetics trend prediction service which enables to reflect cosmetics trends from a customer's perspective required in the cosmetics market in real time by analyzing cosmetics-related products and cosmetics-related social data.

### 2. Description of Related Art

In general, cosmetics trends change very quickly, and there are various factors affecting this change.

These changes in cosmetics trends make it impossible for cosmetics that are successful in the market this year to guarantee success next year.

Because predicting cosmetics trends is very difficult, cosmetics manufacturers are spending a lot of time and money for researching cosmetics trends that will be popular in the market to avoid major losses due to incorrect trend predictions.

Cosmetics manufacturers are analyzing and researching cosmetics trends and creating trend reports to predict trends in the cosmetics market.

The trend report contains various factors such as the color, shape, and social atmosphere of specific cosmetics that will be popular in the cosmetics market.

Cosmetics manufacturers can design and produce cosmetics by setting design and color directions and concepts based on trend reports.

However, the conventional cosmetics trend analysis method has the problem of making it difficult to accurately predict cosmetics trends because it mainly analyzes cosmetics trends from a supplier-oriented perspective rather than analyzing cosmetics trends from a customer's perspective. Due to the inability to identify new products, new product planning and marketing activities are inefficient, and market responsiveness is reduced.

Therefore, in the future, there is a need to develop an apparatus for providing a cosmetics trend prediction service that can reflect cosmetics trends from the customer's perspective required in the market in real time.

### SUMMARY

The present disclosure is to provide an apparatus, method, and program for providing a cosmetics trend prediction service which enables to provide a main screen including various service items to a user terminal, provide cosmetics trend prediction information corresponding to the user's service item selection, and provide the cosmetics trend prediction information in various visualized forms that reflects trends from a customer's perspective required in the market in real time by extracting tags and keywords from cosmetics-related product data and cosmetics-related social data, and analyzing and predicting the cosmetics trends.

The problems to be solved by the present disclosure are not limited to the problems mentioned above, and other problems not mentioned can be clearly understood by those skilled in the art from the description below.

In an aspect of the present disclosure, an apparatus for providing cosmetics trend prediction service comprising a user terminal and a platform server connected to an external server, wherein the platform server includes: a communication unit connected to the user terminal and the external server and configured to receive cosmetics-related product data and cosmetics-related social data; a preprocessing unit configured to process the cosmetics-related product data and the cosmetics-related social data; a tag generating unit configured to classify the processed cosmetics-related product data and cosmetics-related social data and generate a corresponding tag; a keyword extracting unit configured to extract a keyword from the tag, the cosmetics-related product data, and the cosmetics-related social data; a cosmetics trend prediction unit configured to analyze and predict a cosmetics trend based on the extracted keyword; and a control unit configured to control the communication unit, the preprocessing unit, the tag generating unit, the keyword extracting unit, and the cosmetics trend prediction unit, wherein the control unit is configured to: based on collecting the cosmetics-related product data and the cosmetics-related social data through the communication unit, control the preprocessing unit, the tag generating unit, and the keyword extracting unit to automatically classify the collected cosmetics-related product data and the cosmetics-related social data by cosmetics categories, generate the corresponding tag, and extract the keyword, control the cosmetics trend prediction unit to analyze and predict the cosmetics trend based on the tag and keyword, based on receiving a request for cosmetics trend prediction service from the user terminal, provide the cosmetics trend prediction service to the user terminal to display a main screen including at least one service item among a cosmetics schema item, a cosmetics-related product data item, a cosmetics-related social data item, a cosmetics keyword item, a cosmetics trend analysis item, and a cosmetics trend prediction item, and based on receiving a user selection input for selecting a service item included in the main screen from the user terminal, provide corresponding cosmetics trend prediction information.

In addition, based on receiving the user selection input for selecting the cosmetics schema item among the service items, the control unit may be configured to provide a tag tree including a plurality of main tags that firstly classify cosmetics by use, sub tags that secondly classify each main tag by color, composition, and area, and detailed tags that thirdly classify each sub-tag according to detailed information, a user selection box for each tag, and a tag add button.

In addition, based on receiving the user selection input for selecting the cosmetics-related product data item among the service items, the control unit may be configured to provide a plurality of brand tags that firstly classify cosmetics by brand, product tags that secondly classify cosmetics products corresponding to each brand tag, a user-selected tag table, a cosmetics-related image corresponding to the user-selected tag, a keyword table corresponding to the user-selected tag, and a button to go to a relevant site.

In addition, based on receiving the user selection input for selecting the cosmetics-related social data item among the service items, the control unit may be configured to provide a category item classifying cosmetics by category, a social media item classifying cosmetics by social media, a cosmetic type item classifying cosmetics by type, a review author item classified by review author, an input field for review author search term, a user selection box for each classification item, a cosmetics image, cosmetics detailed information of cosmetics, and a search result field including a keyword for cosmetics.

In addition, based on receiving the user selection input for selecting the cosmetics keyword item among the service items, the control unit may be configured to provide a tag filter field for a cosmetics type selection item and a tag selection, a search word input field, and a search results field containing a main keyword, a frequency of appearance of the main keyword, and a table of co-occurrence keywords correspondence to the main keyword.

In addition, based on receiving the user selection input for selecting the cosmetics trend analysis item among the service items, the control unit may be configured to provide a media filter item, a keyword filter item, a cosmetics type input item, a central tag input item, sub-tags corresponding to the input central tag, a user selection box for each sub-tag, related tags, a user selection box for each related tag, and a cosmetics trend visualization button.

In addition, based on receiving the user input for selecting the cosmetics trend visualization button, the control unit may be configured to provide the cosmetics trend analysis information by visualizing a sub-tag and a related tag corresponding to the central tag in a form of a bubble or a related network.

In addition, based on receiving the user selection input for selecting the cosmetics trend prediction item among the service items, the control unit may be configured to provide a plurality of main tag selection items that categorize cosmetics by use, a sub-tag input field for the main tag selection item, a trend makeup method input field for the input sub-tag, a palette configuration method input field for the input trend makeup method, a palette number input field for the palette configuration method, and a formulation input field for the input number of palettes.

In another aspect of the present disclosure, a method for providing cosmetics trend prediction service, the method performed by a platform server may include:

In addition, collecting cosmetics-related product data and cosmetics-related social data; automatically classifying the collected cosmetics-related product data and cosmetics-related social data into cosmetics categories, generating a corresponding tag and keyword; analyzing and predicting the cosmetics trend based on the tag and keyword; based on receiving a request for cosmetics trend prediction service from a user terminal, providing the cosmetics trend prediction service to the user terminal to display a main screen including at least one service item among a cosmetics schema item, a cosmetics-related product data item, a cosmetics-related social data item, a cosmetics keyword item, a cosmetics trend analysis item, and a cosmetics trend prediction item, and based on receiving a user selection input for selecting a service item included in the main screen from the user terminal, providing corresponding cosmetics trend prediction information.

In addition, providing the corresponding cosmetics trend prediction information may include: based on receiving the user selection input for selecting the cosmetics schema item among the service items, providing a tag tree including a plurality of main tags that firstly classify cosmetics by use, sub tags that secondly classify each main tag by color, composition, and area, and detailed tags that thirdly classify each sub-tag according to detailed information, a user selection box for each tag, and a tag add button.

In addition, providing the corresponding cosmetics trend prediction information may include: based on receiving the user selection input for selecting the cosmetics-related product data item among the service items, providing a plurality of brand tags that firstly classify cosmetics by brand, product tags that secondly classify cosmetics products corresponding to each brand tag, a user-selected tag table, a cosmetics-related image corresponding to the user-selected tag, a keyword table corresponding to the user-selected tag, and a button to go to a relevant site.

In addition, providing the corresponding cosmetics trend prediction information may include: based on receiving the user selection input for selecting the cosmetics-related social data item among the service items, providing a category item classifying cosmetics by category, a social media item classifying cosmetics by social media, a cosmetic type item classifying cosmetics by type, a review author item classified by review author, an input field for review author search term, a user selection box for each classification item, a cosmetics image, cosmetics detailed information of cosmetics, and a search result field including a keyword for cosmetics.

In addition, providing the corresponding cosmetics trend prediction information may include: based on receiving the user selection input for selecting the cosmetics keyword item among the service items, providing a tag filter field for a cosmetics type selection item and a tag selection, a search word input field, and a search results field containing a main keyword, a frequency of appearance of the main keyword, and a table of co-occurrence keywords correspondence to the main keyword.

In addition, a computer program for executing a method for implementing the present disclosure stored in a computer-readable recording medium may be further provided.

In addition, a computer-readable recording medium recording a computer program for executing a method for implementing the present disclosure may be further provided.

### BRIEF DESCRIPTION OF THE FIGURES

FIG. 1 is a schematic diagram for describing an apparatus for providing a cosmetics trend prediction service according to the present disclosure.

FIG. 2 is a block diagram for describing the platform server shown in FIG. 1.

FIG. 3 is a diagram for describing a process of providing a cosmetics trend prediction service by a platform server according to the present disclosure.

FIGS. 4 to 12 are diagrams illustrating a screen of providing a cosmetics trend prediction service provided from a platform server according to the present disclosure.

FIG. 13 is a flowchart for describing a method of providing a cosmetics trend prediction service according to the present disclosure.

### DETAILED DESCRIPTION

The advantages and features of the present disclosure, and methods for achieving them, will become clear with reference to the embodiments described in detail below along with the accompanying drawings. However, the present disclosure is not limited to the embodiments disclosed below and may be implemented in various different forms. The present embodiments are merely provided to ensure that the present disclosure is complete, and provided to fully convey the scope of the present disclosure to those skilled in the art to which the present disclosure pertains. The present disclosure is defined only by the scope of the claims.

The terminology used herein is for the purpose of describing embodiments and is not intended to limit the disclosure. As used herein, singular forms also include plural forms, unless specifically stated otherwise in the context. As used in the specification, “comprises” and/or “comprising” does not exclude the presence or addition of one or more other elements in addition to the mentioned elements. The same reference numerals refer to the same elements throughout the specification, and “and/or” includes each and every combination of one or more of the referenced elements. Although “first”, “second”, and the like are used to describe various components, these components are of course not limited by these terms. These terms are merely used to distinguish one component from another. Therefore, the first component mentioned below may also be the second component within the technical spirit of the present disclosure.

Unless otherwise defined, all terms (including technical and scientific terms) used in this specification may be used with meanings commonly understood by those skilled in the art to which this disclosure pertains. Additionally, terms defined in commonly used dictionaries are not to be interpreted ideally or excessively unless clearly specifically defined.

Hereinafter, the embodiments of the present disclosure will be described in detail with reference to the attached drawings.

Prior to description, the meaning of terms used in this specification will be briefly described. However, since the description of terms is intended to help understanding of the present specification, it should be noted that if it is not explicitly described as limiting the present disclosure, it is not used in the meaning of limiting the technical idea of the present disclosure.

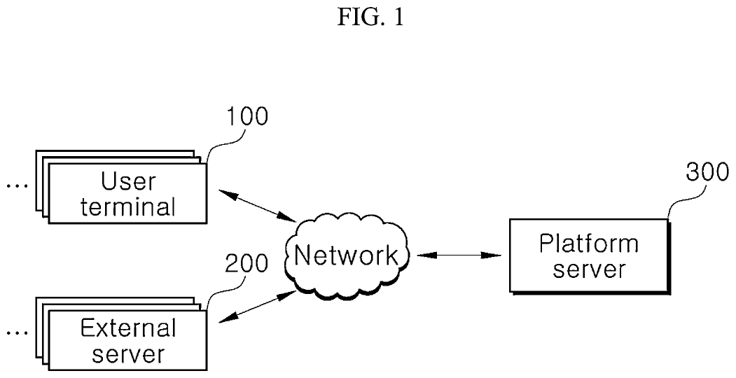

FIG. 1 is a schematic diagram for describing an apparatus for providing a cosmetics trend prediction service according to the present disclosure.

As shown in FIG. 1, the apparatus for providing a cosmetics trend prediction service according to the present disclosure may include a platform server 300 that is connected to a user terminal 100 and an external server 200 through a network.

Here, the user terminal 100 may include both a fixed (standing) device such as a PC (Personal Computer), a Network TV (Network TV), an HBBTV (Hybrid Broadcast Broadband TV), a Smart TV (Smart TV), an IPTV (Internet Protocol TV), and the like and a mobile device (or handheld device) such as a smart phone, a tablet PC, a notebook, a personal digital assistant (PDA) and the like.

The network connecting communication between the user terminal 100, the external server 200, and the platform server 300 includes both wired and wireless networks, and refers to a communication network that supports various communication standards or protocols for pairing and/or data transmission/reception between the user terminal 100 and the platform server 300, and between the external server 200 and the platform server 300.

The wired/wireless network includes all communication networks that are currently or will be supported in the future according to the standard, and may support one or more communication protocols therefor.

The wired/wireless network may be established by the network for wired connection and communication standard or protocol therefor such as USB (Universal Serial Bus), CVBS (Composite Video Banking Sync), Component, S-Video (analog), DVI (Digital Visual Interface), HDMI (High Definition Multimedia). Interface), RGB, and D-SUB and the network for wireless connection and communication standard or protocol therefor such as Bluetooth, RFID (Radio Frequency Identification), infrared communication (IrDA: infrared Data Association), UWB (Ultra-Wideband), ZigBee, DLNA (Digital Living Network Alliance), WLAN (Wireless LAN) (Wi-Fi), Wibro (Wireless broadband), Wimax (World Interoperability for Microwave Access), HSDPA (High Speed Downlink Packet Access), LTE/LTE-A (Long Term Evolution/LTE-Advanced), and Wi-Fi direct.

When the platform server 300 collects cosmetics-related product data and cosmetics-related social data from the user terminal 100 and the external server 200, the platform server 300 may automatically classify the collected cosmetics-related product data and cosmetics-related social data into cosmetics categories, generate the corresponding tag, and extract the keyword, analyze and predict the cosmetics trend based on the tag and keyword, based on receiving a request for cosmetics trend prediction service from the user terminal 100, provide the cosmetics trend prediction service to the user terminal 100 to display a main screen including at least one service item among a cosmetics schema item, a cosmetics-related product data item, a cosmetics-related social data item, a cosmetics keyword item, a cosmetics trend analysis item, and a cosmetics trend prediction item, and based on receiving a user selection input for selecting a service item included in the main screen from the user terminal 100, provide corresponding cosmetics trend prediction information.

Here, the platform server 300 may collect the cosmetics-related product data through a cosmetics information input device, a brand site collection webbot, and a social network collection webbot, and collect the social data through a social network collection webbot.

As an example, when collecting the social data, the platform server 300 may collects the social data from the content of a designated influencer, the content of first users connected to the designated influencer, and the content of second users using the content of the designated influencer and the first users, but this is only an example and is not limited thereto.

For example, the social data may include at least one of a text written in the content, an attached image, an author, a creation date, an attached script, and information on connected users, and the attached script may include a caption, the connected users may include at least one of a comment, a subscription, and a friend, but this is only an example and is not limited thereto.

The platform server 300, when collecting the cosmetics-related product data and the cosmetics-related social data, may check whether a text is included in the cosmetics-related product data and the cosmetics-related social data, and, in the case that a text is included, may extract a first keyword corresponding to the attribute of a specific cosmetic from the text.

Next, when collecting the cosmetics-related product data and the cosmetics-related social data, the platform server 300 may generate a highlight capture image by highlight capturing a video in the case that the cosmetics-related product data and the social data include the video, detect a specific cosmetics from the highlight capture image, extract a specific cosmetics image from the highlight capture image for the detected specific cosmetics, and generate structured data from the extracted specific cosmetics image.

As an example, the structured data generated from the extracted specific cosmetics image may include at least one of color or pattern of the specific cosmetics, but this is only an example and is not limited thereto.

Additionally, when the highlight capture image is generated, the platform server 300 may extract a text from the highlight capture image and generate unstructured data based on the extracted text.

Here, the text may be extracted from the highlight capture image through optical character recognition, but this is only an example and is not limited thereto.

In addition, when collecting the cosmetics-related product data and the social data, in the case that the cosmetics-related product data and the social data include a video, the platform server 300 may extract a voice from the video and convert the voice into a text, and generate the unstructured data based on the converted text.

Here, the text conversion process may convert a voice into a text through STT (Speech-to-Text), but this is only an example and is not limited thereto.

Next, when collecting the cosmetics-related product data and the social data, in the case that the cosmetics-related product data and the social data include a still image, the platform server 300 may detect a specific cosmetics from the still image, extract a specific cosmetic image from the still image for the specific detected cosmetic product, and generate the structured data from the extracted specific cosmetic image.

As an example, the structured data generated from the extracted specific cosmetics image may include at least one of color or pattern of the specific cosmetics, but this is only an example and is not limited thereto.

Additionally, the platform server 300 may extract the text from the still image and generate the unstructured data based on the extracted text.

Here, the text may be extracted from the still image through optical character recognition, but this is only an example and is not limited thereto.

Next, when collecting the cosmetics-related product data and the social data, in the case that the cosmetics-related product data and the social data include a text, the platform server 300 may generate the unstructured data from the text.

The platform server 300 may automatically classify unstructured data or structured data into categories of cosmetics and generate a tag for each of the automatically classified unstructured data and structured data.

Here, when automatically classifying the unstructured data or the structured data, the platform server 300 may automatically classify cosmetics by category by inputting the generated unstructured data or structured data into a pre-trained artificial intelligence model.

As an example, the artificial intelligence model may include a machine learning model including a neural network.

In other words, the artificial intelligence model of the present disclosure may be pre-trained to automatically classify cosmetics by category based on unstructured data or structured data of the cosmetics-related product data and the social data.

Additionally, the artificial intelligence model of the present disclosure may be a deep neural network. Throughout this specification, neural network, network function, and neural network may be used interchangeably. A deep neural network (DNN) may refer to a neural network that includes a plurality of hidden layers in addition to an input layer and an output layer. The deep neural network enables to identify latent structures in data. In other words, it is possible to identify the potential structure of a photo, text, video, voice, or music (e.g., what object is in the photo, what the content and emotion of the text are, what the content and emotion of the voice are, etc.). The deep neural network may include convolutional neural network (CNN), recurrent neural network (RNN), restricted Boltzmann machine (RBM), and deep belief network (DBN), Q network, U network, Siamese network, and the like.

When the platform server 300 generates tags, the platform server 300 may firstly classify the tags by cosmetics, secondarily classify the firstly classified tags by part of each cosmetic, and thirdly classify the secondarily classified tags by characteristics and attributes for a specific part of each cosmetics, and create and store a tag tree of the classified tags.

Next, the platform server 300 may further classify and store the first keyword extracted from the cosmetics-related product data and the social data and the second keyword extracted from the tags by category.

Here, the platform server 300 may firstly classify the first keywords extracted from the cosmetics-related product data by brand, and store the keywords for each brand classified firstly by secondly classifying them by cosmetics.

As an example, the platform server 300 may classify and store the first keywords extracted from the social data related to cosmetics by category, social media, and cosmetic type.

For example, the classification by category may be classified by brand, analysis review, and response review, but this is only an example and is not limited thereto.

The classification by social media may be classified by Instagram and blog, but this is only an example and is not limited thereto.

Additionally, the platform server 300 may classify and store the second keywords extracted from the tag by cosmetic type, tag, and frequency of appearance.

Then, when analyzing the cosmetics trend based on the extracted first and second keywords, the platform server 300 may select a media filter, a keyword filter, a cosmetics type, a central tag, and a related tag, and analyze the cosmetics trends based on the corresponding keyword.

Here, the media filter may include a brand filter, an analysis review filter, and a reaction review filter, but this is only an example and is not limited thereto.

Next, when predicting the cosmetics trend based on the extracted first and second keywords, the platform server 300 may select the cosmetics type, central tag, related tag, and cosmetics configuration method to predict the corresponding cosmetics trend.

Here, when the cosmetics trend is predicted, the platform server 300 may store predicted cosmetics images and predicted cosmetics information for the predicted cosmetics trend according to predicted popularity ranking.

Based on receiving the user selection input for selecting the cosmetics schema item among the service items in the main screen, the platform server 300 may provide a tag tree including a plurality of main tags that firstly classify cosmetics by use, sub tags that secondly classify each main tag by color, composition, and area, and detailed tags that thirdly classify each sub-tag according to detailed information, a user selection box for each tag, and a tag add button.

As an example, the main tag may include shadow, cream, lip, blusher, and makeup, and the shadow-related sub tags may include color, number of palettes, and area, and the color-related detailed tags may include color, saturation, brightness, tone, pearl color, and the like., but this is only an example and is not limited thereto.

Next, based on receiving the user selection input for selecting the cosmetics-related product data item among the service items on the main screen, the platform server 300 may provide a plurality of brand tags that firstly classify cosmetics by brand, product tags that secondly classify cosmetics products corresponding to each brand tag, a user-selected tag table, a cosmetics-related image corresponding to the user-selected tag, a keyword table corresponding to the user-selected tag, and a button to go to a relevant site.

In addition, based on receiving the user selection input for selecting the cosmetics-related social data item among the service items on the main screen, the platform server 300 may provide a category item classifying cosmetics by category, a social media item classifying cosmetics by social media, a cosmetic type item classifying cosmetics by type, a review author item classified by review author, an input field for review author search term, a user selection box for each classification item, a cosmetics image, cosmetics detailed information of cosmetics, and a search result field including a keyword for cosmetics.

As an example, the category item may include sub-items for brands, analysis reviews, reactions, and the like, and the social media item may include sub-items for Instagram, Naver Blog, Women's Generation, Powder Room, and the like. The cosmetics type item may include sub-items for all, shadow, and cream, but this is only an example and is not limited thereto.

In addition, based on receiving the user selection input for selecting the cosmetics keyword item among the service items on the main screen, the platform server 300 may provide a tag filter field for a cosmetics type selection item and a tag selection, a search word input field, and a search results field containing a main keyword, a frequency of appearance of the main keyword, and a table of co-occurrence keywords correspondence to the main keyword.

In addition, based on receiving the user selection input for selecting the cosmetics trend analysis item among the service items on the main screen, the platform server 300 may provide a media filter item, a keyword filter item, a cosmetics type input item, a central tag input item, sub-tags corresponding to the input central tag, a user selection box for each sub-tag, related tags, a user selection box for each related tag, and a cosmetics trend visualization button.

Here, based on receiving the user input for selecting the cosmetics trend visualization button, the platform server 300 may provide the cosmetics trend analysis information by visualizing a sub-tag and a related tag corresponding to the central tag in a form of a bubble or a related network.

In addition, based on receiving the user selection input for selecting the cosmetics trend prediction item among the service items on the main screen, the platform server 300 may provide a plurality of main tag selection items that categorize cosmetics by use, a sub-tag input field for the main tag selection item, a trend makeup method input field for the input sub-tag, a palette configuration method input field for the input trend makeup method, a palette number input field for the palette configuration method, and a formulation input field for the input number of palettes.

In addition, when a cosmetics trend prediction service request is received from the user terminal 100, the platform server 300 may transmit a first keyword list related to the type of cosmetics, a second keyword list related to the central tag, a third keyword list related to the related tag, and a fourth keyword list related to the cosmetic composition method to the user terminal, and when a completion of user keyword selection for the first to fourth keyword lists is received from the user terminal, process predicted cosmetics image and predicted cosmetics information of the predicted cosmetics trend corresponding to the user keyword selection to be displayed by predicted popularity ranking and transmit it to the user terminal.

Here, when the platform server 300 transmits the first to fourth keyword lists to the user terminal, the platform server 300 may generate the first keywords related to the cosmetic type, the second keywords related to the central tag, the third keywords related to the related tag, and fourth keywords related to the composition method of cosmetics to be listed by frequency of occurrence, and transmit the generated first to fourth keyword lists to the user terminal.

In some cases, when the cosmetics trend prediction service request is received from the user terminal 100, the platform server 300 may visualize the predicted cosmetics image of the cosmetics trend predicted according to the user's selection to be displayed in the form of a related network, and transmit it to the user terminal 100.

In another case, when the cosmetics trend prediction service request is received from the user terminal 100, the platform server 300 may visualize the predicted cosmetics keywords of the cosmetics trend predicted according to the user's selection to be displayed in the form of a related network, and transmit it to the user terminal.

Then, the platform server 300, when receiving the completion of user keyword selection for the first to fourth keyword list from the user terminal 100, the platform server 300 may combine and configure the first to fourth keywords selected by the user, and search for the predicted cosmetics image and predicted cosmetics information for cosmetics trends predicted based on complex keywords.

In addition, the platform server 300 may select keywords of interest based on the extracted first and second keywords, combine and configure the selected keywords of interest, set a search condition based on the combined complex keywords, search a cosmetics trend using the set search condition, and analyze and predict the searched cosmetics trend.

As an example, the platform server 300 may select the keywords of interest based on the extracted first and second keywords to create the first keyword list, select issue keywords and combine and configure the keywords of interest and the issue keywords to create the second keyword list, select detailed attribute keywords and combine and configure the keywords of interest, the issue keywords, and the detailed attribute keywords to create the third keyword list, select usability keywords and combine and configure the interest keywords, the issue keywords, the detailed attribute keywords, and the usability keywords to create the fourth keyword list, and accordingly, the platform server 300 may set search conditions based on the fourth keyword list, search for the cosmetics trend using the set search condition, and analyze and predict the searched cosmetics trend.

As another example, the platform server 300 may generate the first keyword list by selecting keywords of interest based on the extracted first and second keywords, the second keyword list by combining and configuring the keywords of interest and emphasis keywords by selecting the keywords of interest and the emphasis keywords or combining and configuring the keywords of interest and color keywords, third keyword list by combining and configuring cosmetics category keywords and brand keywords by selecting the cosmetics category keywords and the brand keywords, and accordingly, the platform server 300 may set search conditions based on the first, second, and third keyword lists, search for the cosmetics trends using the set search condition, and analyze and predict the searched cosmetics trend.

Additionally, when analyzing and predicting the searched cosmetics trend, the platform server 300 may search, analyze, and predict the cosmetics trends by inputting the search condition into a pre-trained artificial intelligence model.

As an example, the artificial intelligence model may include a machine learning model including a neural network.

In other words, the artificial intelligence model of the present disclosure may be pre-trained to search, analyze, and predict the cosmetics trend based on the search condition.

Next, when predicting the cosmetics trend based on the extracted first and second keywords, the platform server 300 may input a user question about the cosmetics trend into the pre-trained artificial intelligence model to analyze and predict the cosmetics trend corresponding to the user question.

Here, the artificial intelligence model may analyze the user question when the user question about the cosmetics trend is inputted, extract and combine the keywords corresponding to the user question to create the search condition, and search, analyze and predict the cosmetics trend based on the search condition.

As an example, the artificial intelligence model may include a machine learning model including a neural network.

In other words, the artificial intelligence model of the present disclosure be pre-trained to search, analyze, and predict the cosmetics trend based on the user question about the cosmetics trend.

In addition, the artificial intelligence model of the present disclosure may be a deep neural network, and the deep neural network (DNN) may refer to a neural network that includes a plurality of hidden layers in addition to an input layer and an output layer. The deep neural network enables to identify latent structures in data. In other words, it is possible to identify the potential structure of a photo, text, video, voice, or music (e.g., what object is in the photo, what the content and emotion of the text are, what the content and emotion of the voice are, etc.). The deep neural network may include convolutional neural network (CNN), recurrent neural network (RNN), restricted Boltzmann machine (RBM), and deep belief network (DBN), Q network, U network, Siamese network, and the like.

In this way, according to the present disclosure, a tag and a keyword are extracted from the cosmetics-related product data and the cosmetics-related social data to analyze and predict the cosmetics trend, thereby providing a main screen containing various service items to the user terminal, providing the cosmetics trend prediction information corresponding to the selection of service items of the user, and providing the cosmetics trend prediction information that reflects trends from the customer's perspective required in the market in real time in a visualized manner in various forms.

In addition, according to the present disclosure, the market responsiveness may be increased in a company's sales activities and execution, such as new product planning and marketing activities, by matching consumer needs and cosmetics characteristics.

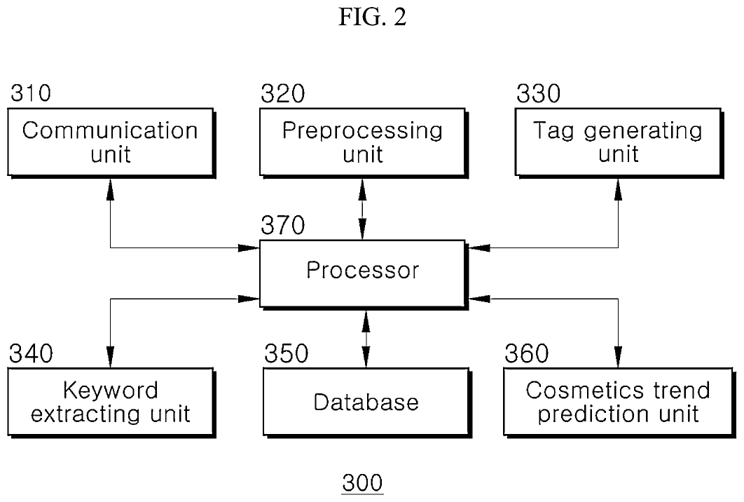

FIG. 2 is a block diagram for describing the platform server shown in FIG. 1.

As shown in FIG. 2, the platform server 300 of the present disclosure may include a communication unit 310 connected to the user terminal and the external server and configured to receive cosmetics-related product data and cosmetics-related social data, a preprocessing unit 320 configured to process the cosmetics-related product data and the cosmetics-related social data, a tag generating unit 330 configured to classify the processed cosmetics-related product data and cosmetics-related social data and generate a corresponding tag, a keyword extracting unit 340 configured to extract a keyword from the tag, the cosmetics-related product data, and the cosmetics-related social data, a cosmetics trend prediction unit 350 configured to analyze and predict a cosmetics trend based on the extracted keyword, a database 360 configured to store cosmetics data, social data, their tags and keywords, and analysis and predicted cosmetics trend information, and the control unit 370 configured to control the communication unit 310, the preprocessing unit 320, the tag generating unit 330, the keyword extracting unit 340, the database 360, and the cosmetics trend prediction unit 350.

Here, the control unit 370, based on collecting the cosmetics-related product data and the cosmetics-related social data through the communication unit, may control the preprocessing unit 320, the tag generating unit 330, and the keyword extracting unit 340 to automatically classify the collected cosmetics-related product data and the cosmetics-related social data into cosmetics categories, generate the corresponding tag, and extract the keyword, control the cosmetics trend prediction unit 360 to analyze and predict the cosmetics trend based on the tag and keyword, based on receiving a request for cosmetics trend prediction service from the user terminal, provide the cosmetics trend prediction service to the user terminal to display a main screen including at least one service item among a cosmetics schema item, a cosmetics-related product data item, a cosmetics-related social data item, a cosmetics keyword item, a cosmetics trend analysis item, and a cosmetics trend prediction item, and based on receiving a user selection input for selecting a service item included in the main screen from the user terminal, provide corresponding cosmetics trend prediction information.

Additionally, when a text is included in the collected cosmetics-related product data and the social data, the keyword extracting unit 340 may extract a first keyword corresponding to the attribute of a specific cosmetic from the text.

Next, in the case that the collected cosmetics-related product data and the social data include a video, the preprocessing unit 320 may generate a highlight capture image by highlight-capturing the video, detect a specific cosmetic from the highlight capture image, extract a specific cosmetic image from the highlight capture image for the detected specific cosmetic, and generate structured data from the extracted specific cosmetic image.

Additionally, when the highlight capture image is generated, the preprocessing unit 320 may extract a text from the highlight capture image and generate unstructured data based on the extracted text.

In addition, in the case that the collected cosmetics-related product data and the social data include a video, the preprocessing unit 320 may extract voice from the video, convert the voice into text, and generate unstructured data based on the converted text.

Furthermore, in the case that a still image is included in the collected cosmetics-related product data and the social data, the preprocessing unit 320 may detect a specific cosmetic from the still image, extract a specific cosmetic image from the still image, and generate structured data from the extracted specific cosmetic image.

Additionally, the preprocessing unit 320 may extract a text from the still image and generate unstructured data based on the extracted text.

In addition, in the case that the collected cosmetics-related product data and the social data include a text, the preprocessing unit 320 may generate unstructured data from the text.

The tag generating unit 330 may automatically classify unstructured data or structured data into categories of cosmetics and generate a tag for each automatically classified unstructured data or structured data.

Here, when automatically classifying the unstructured data or the structured data, the tag generating unit 330 may input the generated unstructured data or structured data into a pre-trained artificial intelligence model to automatically classify cosmetics by category.

When analyzing the cosmetics trend based on the extracted first and second keywords, the cosmetics trend prediction unit 350 may select a media filter, a keyword filter, a cosmetics type, a central tag, and a related tag and analyze cosmetics trend based on the corresponding keywords.

In addition, when predicting cosmetics trend based on the extracted first and second keywords, the cosmetics trend prediction unit 350 may select the cosmetics type, the central tag, the related tag, and the cosmetics composition method and predict the corresponding cosmetics trend.

Here, when the cosmetics trend is predicted, the cosmetics trend prediction unit 350 may store the predicted cosmetics image and predicted cosmetics information for the predicted cosmetics trend in the database 360 according to predicted popularity ranking.

In addition, the cosmetics trend prediction unit 350 may select keywords of interest based on the extracted first and second keywords, combine and configure the selected keywords of interest, set a search condition based on the combined and configured complex keywords, search a cosmetics trend using the search condition, and analyze and predict the searched cosmetics trend.

Furthermore, when predicting the cosmetics trend based on the extracted first and second keywords, the cosmetics trend prediction unit 350 may input a user question about the cosmetics trend into a pre-trained artificial intelligence model and analyze and predict the cosmetics trend corresponding to the user question.

Meanwhile, based on receiving the user selection input for selecting the cosmetics schema item among the service items, the control unit 370 may provide a tag tree including a plurality of main tags that firstly classify cosmetics by use, sub tags that secondly classify each main tag by color, composition, and area, and detailed tags that thirdly classify each sub-tag according to detailed information, a user selection box for each tag, and a tag add button.

Next, based on receiving the user selection input for selecting the cosmetics-related product data item among the service items, the control unit 370 may provide a plurality of brand tags that firstly classify cosmetics by brand, product tags that secondly classify cosmetics products corresponding to each brand tag, a user-selected tag table, a cosmetics-related image corresponding to the user-selected tag, a keyword table corresponding to the user-selected tag, and a button to go to a relevant site.

In addition, based on receiving the user selection input for selecting the cosmetics-related social data item among the service items, the control unit 370 may provide a category item classifying cosmetics by category, a social media item classifying cosmetics by social media, a cosmetic type item classifying cosmetics by type, a review author item classified by review author, an input field for review author search term, a user selection box for each classification item, a cosmetics image, cosmetics detailed information of cosmetics, and a search result field including a keyword for cosmetics.

In addition, based on receiving the user selection input for selecting the cosmetics keyword item among the service items, the control unit 370 may provide a tag filter field for a cosmetics type selection item and a tag selection, a search word input field, and a search results field containing a main keyword, a frequency of appearance of the main keyword, and a table of co-occurrence keywords correspondence to the main keyword.

In addition, based on receiving the user selection input for selecting the cosmetics trend analysis item among the service items, the control unit 370 may provide a media filter item, a keyword filter item, a cosmetics type input item, a central tag input item, sub-tags corresponding to the input central tag, a user selection box for each sub-tag, related tags, a user selection box for each related tag, and a cosmetics trend visualization button.

Here, based on receiving the user input for selecting the cosmetics trend visualization button, the control unit 370 may provide the cosmetics trend analysis information by visualizing a sub-tag and a related tag corresponding to the central tag in a form of a bubble or a related network.

In addition, based on receiving the user selection input for selecting the cosmetics trend prediction item among the service items, the control unit 370 may provide a plurality of main tag selection items that categorize cosmetics by use, a sub-tag input field for the main tag selection item, a trend makeup method input field for the input sub-tag, a palette configuration method input field for the input trend makeup method, a palette number input field for the palette configuration method, and a formulation input field for the input number of palettes.

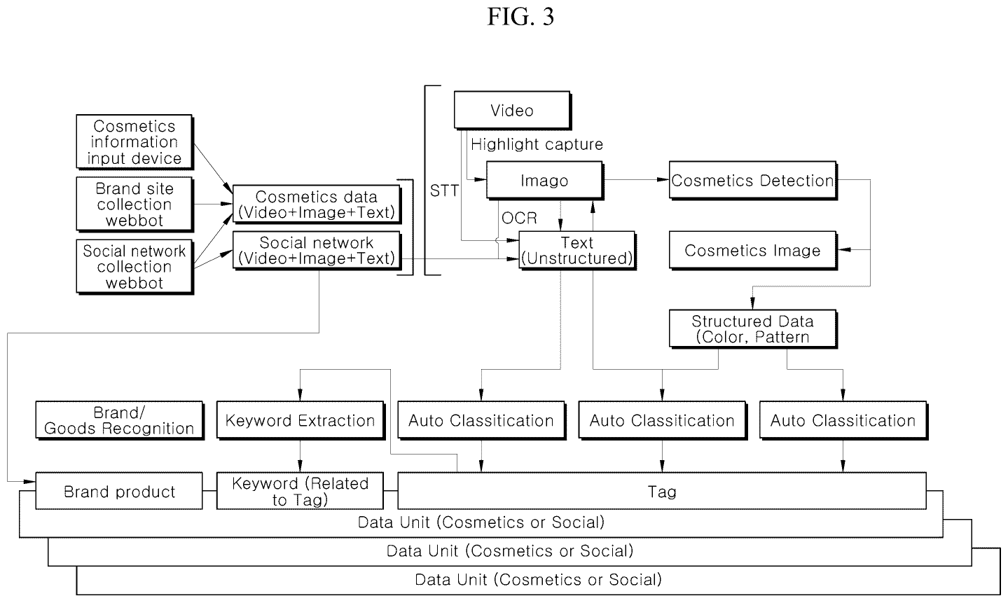

FIG. 3 is a diagram for describing a process of providing a cosmetics trend prediction service by a platform server according to the present disclosure.

As shown in FIG. 3, according to the present disclosure, first, the cosmetics-related product data may be collected through a cosmetics information input device, a brand site collection webbot, and a social network collection webbot, and the social data may be collected through a social network collection webbot.

Additionally, according to the present disclosure, a first keyword corresponding to cosmetics attribute from the cosmetics-related product data and the social data through the keyword extracting unit.

Next, according to the present disclosure, at least one of unstructured data and structured data may be generated by processing a video, a still image, and a text included in the cosmetics-related product data and the social data.

Here, according to the present disclosure, a highlight capture image may be generated by highlight-capturing the video included in the cosmetics-related product data and the social data, a specific cosmetic may be detected from the highlight capture image, a specific cosmetic image may be extracted from the highlight capture image for the detected specific cosmetic, and structured data may be generated from the extracted specific cosmetic image.

In addition, according to the present disclosure, a text may be extracted from the highlight capture image through optical character recognition and unstructured data may be generated based on the extracted text.

In addition, according to the present disclosure, a voice may be extracted from a video, the voice may be converted into a text through STT (Speech-to-Text), and unstructured data may be generated based on the converted text.

Additionally, according to the present disclosure, unstructured data may be generated from the text included in the cosmetics-related product data and the social data.

Next, according to the present disclosure, the unstructured data or the structured data may be automatically classified into categories of cosmetics and a tag may be created for each automatically classified unstructured data or structured data.

According to the present disclosure, when the tag is created, the tag may be firstly classified by cosmetics, the firstly classified tag may be secondly classified by part of each cosmetic, the secondly classified tag may be thirdly classify by characteristics and attribute of a specific part of each cosmetic, and a tag tree may be generated and stored based on the classified tags.

Next, according to the present disclosure, the first keyword extracted from the cosmetics data and the social data and the second keyword extracted from the tags may be further classify and stored by category.

Here, according to the present disclosure, the first keyword extracted from the cosmetics data may be firstly classified by brand, and the keywords for each brand firstly classified may be secondly classified and stored by cosmetics.

In addition, according to the present disclosure, the first keywords extracted from social data may be classified and stored by category, social media, and cosmetics type, and the second keywords extracted from tags by cosmetics type, tag, and appearance may be classified and stored by frequency.

Next, according to the present disclosure, a media filter, a keyword filter, a cosmetic type, a central tag, and a related tag may be selected, and the cosmetics trend may be analyzed based on the corresponding keywords.

In addition, according to the present disclosure, the cosmetic type, the central tag, the related tag, and the cosmetic composition method may be selected, and the corresponding cosmetics trend may be predicted.

Next, according to the present disclosure, when the cosmetics trend is predicted, the predicted cosmetics image and predicted cosmetics information for the predicted cosmetics trend may be stored according to predicted popularity ranking.

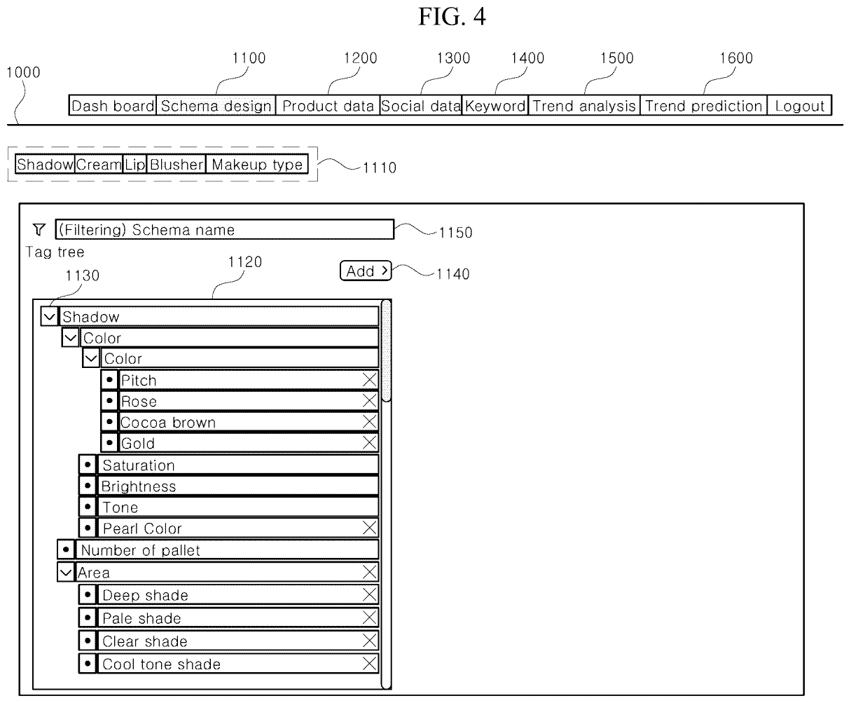

FIGS. 4 to 12 are diagrams illustrating a screen of providing a cosmetics trend prediction service provided from a platform server according to the present disclosure.

As shown in FIGS. 4 to 12, when receiving a cosmetics trend prediction service request from a user terminal, the platform server of the present disclosure may provide a cosmetics trend prediction service to the user terminal so that the main screen 1000 including at least one of a cosmetics schema item 1100, a cosmetics-related product data item 1200, a cosmetics-related social data item 1300, a cosmetics keyword item 1400, a cosmetics trend analysis item 1500, or a cosmetics trend prediction item 1600 is displayed.

As shown in FIG. 4, when receiving the user selection input for selecting the cosmetics schema item 1100 among the service items on the main screen 1000, the platform server may provide a tag tree 1120 including a plurality of main tags 1110 that firstly classify cosmetics by use, sub tags that secondly classify each main tag 1110 by color, composition, and area, and detailed tags that thirdly classify each sub-tag according to detailed information, a user selection box 1130 for each tag, a tag add button 1140, and a schema name input field 1150.

As an example, the main tag may include shadow, cream, lip, blusher, and makeup, and the shadow-related sub tags may include color, number of palettes, and area, and the color-related detailed tags may include color, saturation, brightness, tone, pearl color, and the like., but this is only an example and is not limited thereto.

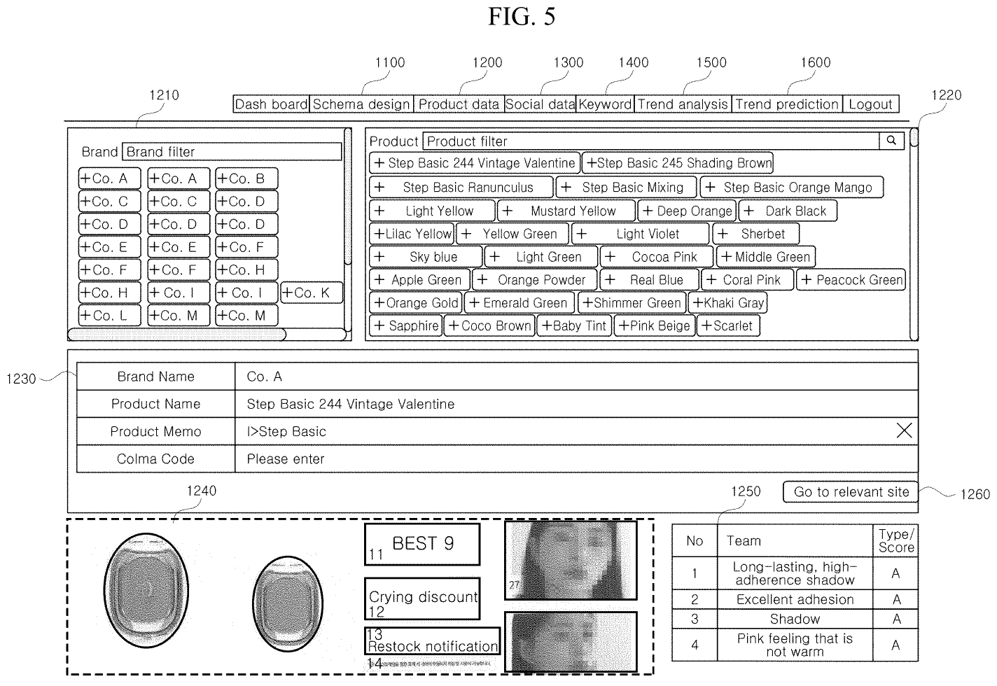

In addition, as shown in FIG. 5, when the platform server receives the user selection input for selecting the cosmetics-related product data item 1200 among the service items on the main screen, the platform server may provide a plurality of brand tags 1210 that firstly classify cosmetics by brand, product tags 1220 that secondly classify cosmetics products corresponding to each brand tag, a user-selected tag table 1230, a cosmetics-related image 1240 corresponding to the user-selected tag, a keyword table 1250 corresponding to the user-selected tag, and a button 1260 to go to a relevant site.

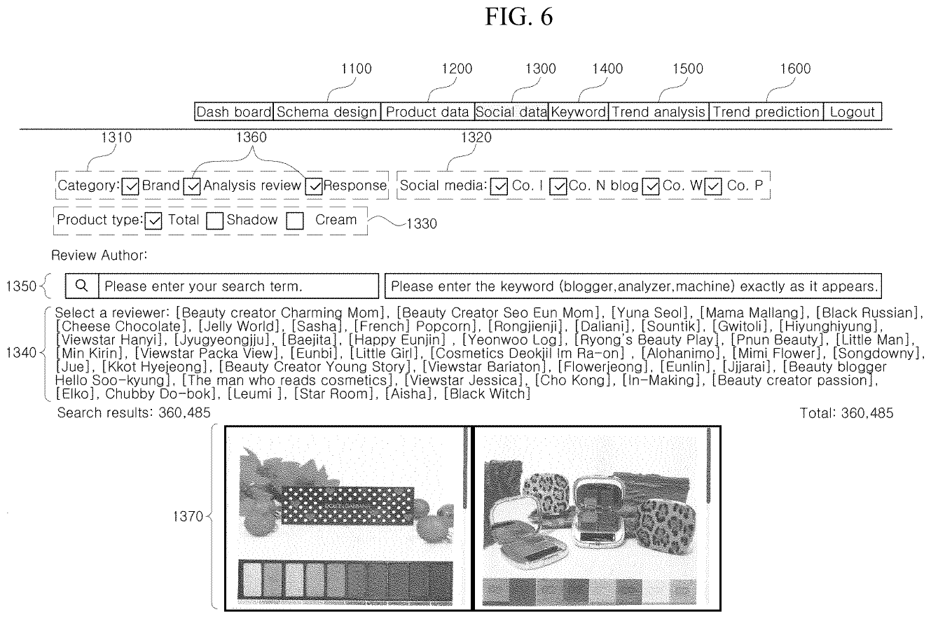

In addition, as shown in FIG. 6, when the user selection input is received for selecting the cosmetics-related social data item 1300 among the service items on the main screen, the platform server may provide a category item 1310 classifying cosmetics by category, a social media item 1320 classifying cosmetics by social media, a cosmetic type item 1330 classifying cosmetics by type, a review author item 1340 classified by review author, an input field 1350 for review author search term, a user selection box 1360 for each classification item, a cosmetics image, cosmetics detailed information of cosmetics, and a search result field 1370 including a keyword for cosmetics.

As an example, the category item 1310 may include sub-items for brands, analysis reviews, reactions, and the like, and the social media item 1320 may include sub-items for Instagram, Naver Blog, Women's Generation, Powder Room, and the like. The cosmetics type item 1330 may include sub-items for all, shadow, and cream, but this is only an example and is not limited thereto.

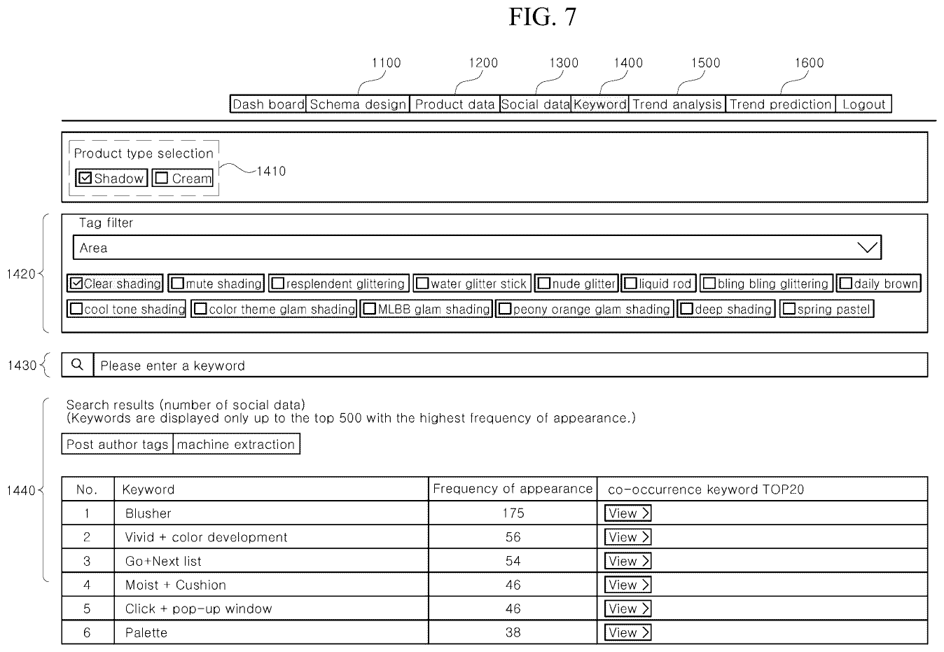

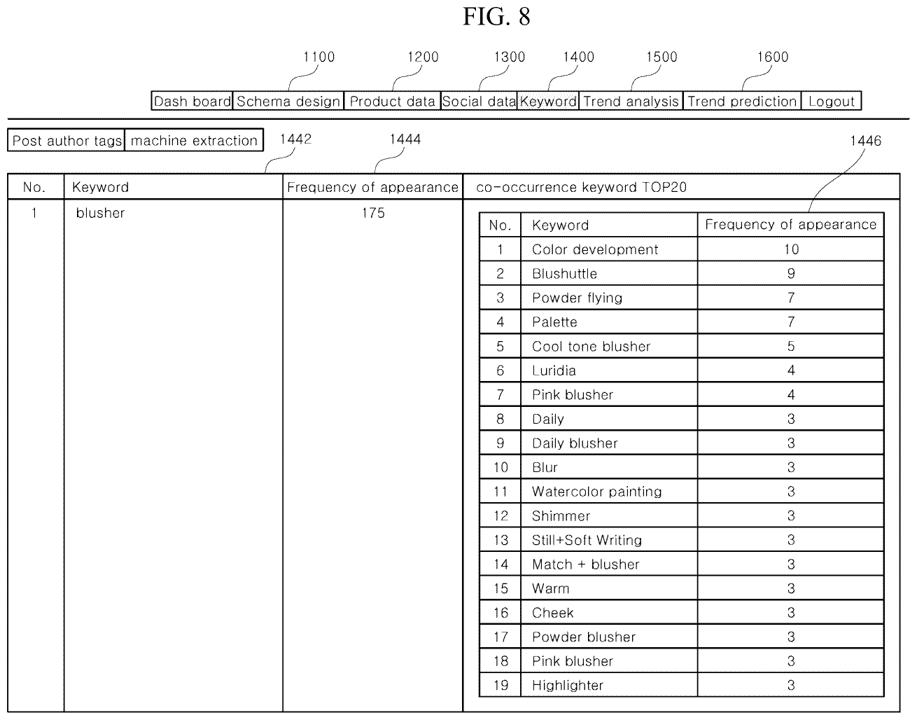

In addition, as shown in FIG. 7 and FIG. 8, when the user selection input is received for selecting the cosmetics keyword item 1400 among the service items on the main screen, the platform server may provide a cosmetics type selection item 1410, a tag filter field 1420 for a tag selection, a search word input field 1430, and a search results field 1440 containing a main keyword 1442, a frequency 1444 of appearance of the main keyword, and a table 1446 of co-occurrence keywords correspondence to the main keyword.

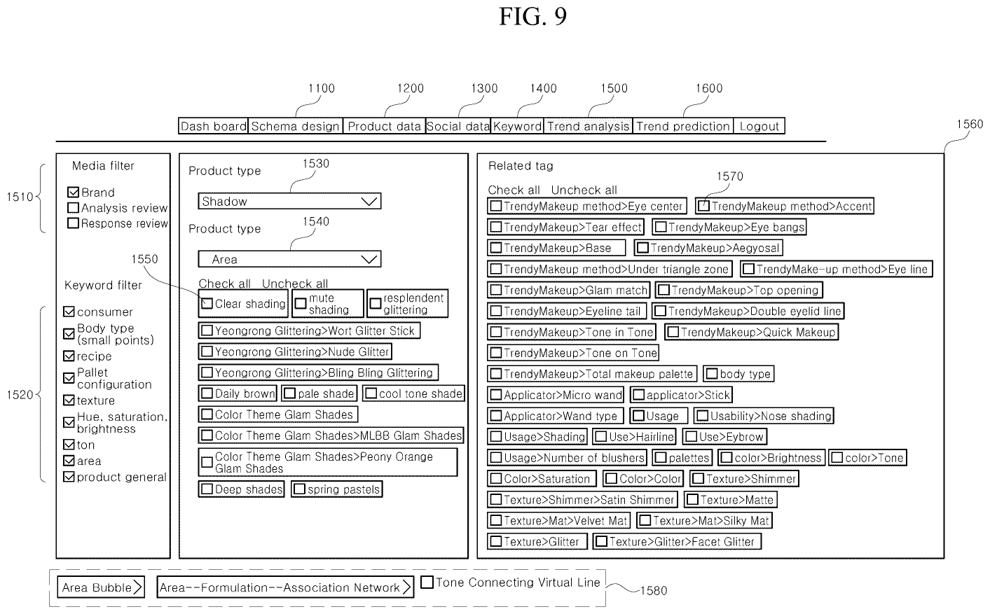

In addition, as shown in FIG. 9, when the user selection input is received for selecting the cosmetics trend analysis item 1500 among the service items on the main screen, the platform server may provide a media filter item 1510, a keyword filter item 1520, a cosmetics type input item 1530, a central tag input item 1540, sub-tags corresponding to the input central tag, a user selection box 1550 for each sub-tag, related tags 1560, a user selection box 1570 for each related tag, and a cosmetics trend visualization button 1580.

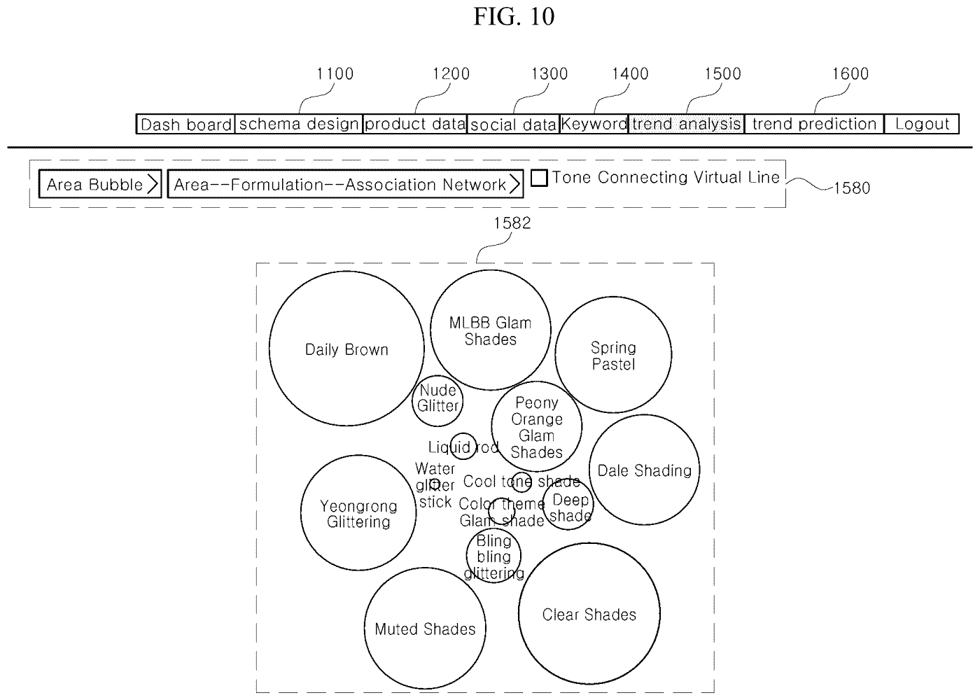

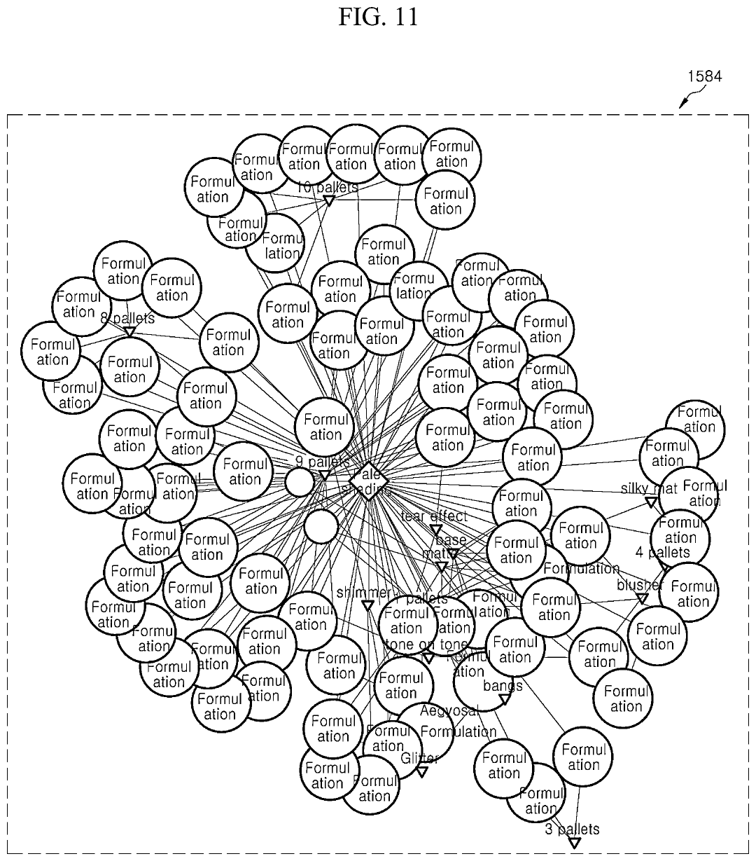

Here, as shown in FIG. 10 and FIG. 11, when the user input is received for selecting the cosmetics trend visualization button 1580, the platform server may provide the cosmetics trend analysis information by visualizing a sub-tag and a related tag corresponding to the central tag in a form of a bubble 1582 or a related network 1584.

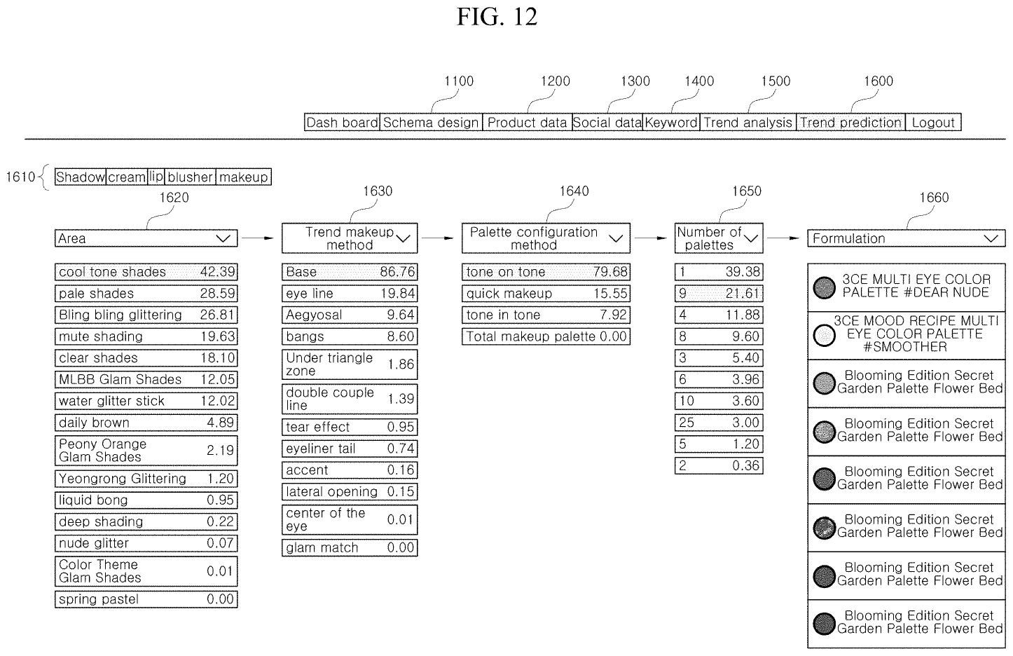

In addition, as shown in FIG. 12, when the user selection input is received for selecting the cosmetics trend prediction item 1600 among the service items on the main screen, the platform server may provide a plurality of main tag selection items 1610 that categorize cosmetics by use, a sub-tag input field 1620 for the main tag selection item 1610, a trend makeup method input field 1630 for the input sub-tag, a palette configuration method input field 1640 for the input trend makeup method, a palette number input field 1650 for the palette configuration method, and a formulation input field 1660 for the input number of palettes.

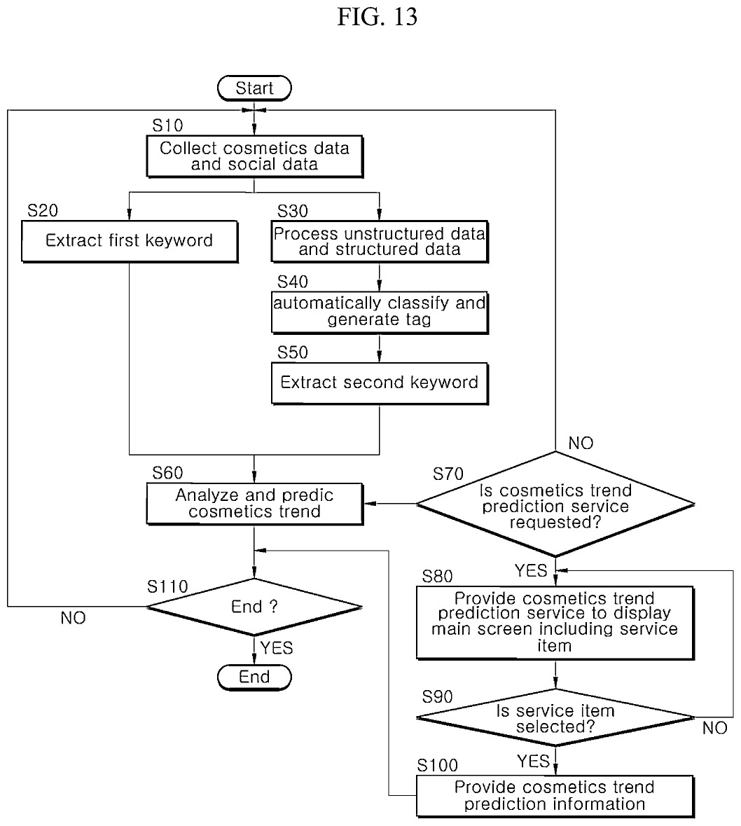

FIG. 13 is a flowchart for describing a method of providing a cosmetics trend prediction service according to the present disclosure.

As shown in FIG. 13, according to the present disclosure, the cosmetics-related product data and the social data may be collected (step S10).

Here, according to the present disclosure, the cosmetics-related product data may be collected through a cosmetics information input device, a brand site collection webbot, and a social network collection webbot, and the social data may be collected through a social network collection webbot.

Additionally, according to the present disclosure, a first keyword corresponding to cosmetics attribute from the cosmetics-related product data and the social data (step S20).

Here, according to the present disclosure, whether a text is included in the cosmetics-related product data and the social data is checked, and when a text is included, a first keyword corresponding to the attribute of a specific cosmetic may be extracted from the text.

Next, according to the present disclosure, at least one of unstructured data and structured data may be generated by processing a video, a still image, and a text included in the cosmetics-related product data and the social data (step S30).

Here, according to the present disclosure, when a video is included in the cosmetics-related product data and the social data, a highlight capture image may be generated by highlight-capturing the video, a specific cosmetic may be detected from the highlight capture image, a specific cosmetic image may be extracted from the highlight capture image for the detected specific cosmetic, and structured data may be generated from the extracted specific cosmetic image.

Additionally, according to the present disclosure, in the case that the cosmetics-related product data and the social data include a still image, a specific cosmetics from the still image may be detected, a specific cosmetic image may be extracted from the still image for the specific detected cosmetic product, and the structured data may be generated from the extracted specific cosmetic image.

Additionally, according to the present disclosure, in the case that the cosmetics-related product data and the social data include a text, unstructured data may be generated from the text.

Next, according to the present disclosure, the unstructured data or the structured data may be automatically classified, and the corresponding tag may be generated (step S40).

Here, according to the present disclosure, the unstructured data or the structured data may be automatically classified into categories of cosmetics, a tag may be generated for each automatically classified unstructured data or structured data.

Subsequently, according to the present disclosure, the second keyword may be extracted from the tag (step S50).

Next, according to the present disclosure, the cosmetics trend may be analyzed and predicted based on the extracted first and second keywords (step S60).

Here, according to the present disclosure, a media filter, a keyword filter, a cosmetic type, a central tag, and a related tag may be selected, and the cosmetics trend may be analyzed based on the corresponding keywords.

In addition, according to the present disclosure, the cosmetic type, the central tag, the related tag, and the cosmetic composition method may be selected, and the corresponding cosmetics trend may be predicted.

Next, according to the present disclosure, when the cosmetics trend is predicted, the predicted cosmetics image and predicted cosmetics information for the predicted cosmetics trend may be stored according to predicted popularity ranking.

Subsequently, according to the present disclosure, whether there is a request for the cosmetics trend prediction service from the user terminal may be checked (step S70).

Next, when the request for the cosmetics trend prediction service is received from the user terminal, the present disclosure may provide a cosmetics trend prediction service to the user terminal so that the main screen including at least one of a cosmetics schema item, a cosmetics-related product data item, a cosmetics-related social data item, a cosmetics keyword item, a cosmetics trend analysis item, or a cosmetics trend prediction item is displayed (step S80).

In addition, according to the present disclosure, whether there is a user selection input for selecting a service item included in the main screen from the user terminal may be checked (step S90).

Next, when the user selection input for selecting a service item included in the main screen is received from the user terminal, the present disclosure may provide the corresponding cosmetics trend prediction information (step S100).

Subsequently, according to the present disclosure, whether a request for termination of the cosmetics trend prediction service is received is checked (step S110), and when the request for termination of the cosmetics trend prediction service is received, the provision of the cosmetics trend prediction service may be terminated.

In this way, according to the present disclosure, a tag and a keyword are extracted from the cosmetics-related product data and the cosmetics-related social data to analyze and predict the cosmetics trend, thereby providing a main screen containing various service items to the user terminal, providing the cosmetics trend prediction information corresponding to the selection of service items of the user, and providing the cosmetics trend prediction information that reflects trends from the customer's perspective required in the market in real time in a visualized manner in various forms.

In addition, according to the present disclosure, the market responsiveness may be increased in a company's sales activities and execution, such as new product planning and marketing activities, by matching consumer needs and cosmetics characteristics.

The method according to an embodiment of the present disclosure described above may be implemented as a program (or application) and stored in a medium to be executed in combination with a server, which is hardware.

The above-mentioned program may include a code encoded in a computer language such as C, C++, JAVA, a machine language, and the like that the processor (CPU) of the computer may read through the device interface of the computer so that the computer reads the program and executes the methods implemented in the program. The code may include a functional code related to a function that defines the necessary functions for executing the methods, and the functions may include a control code related to an execution procedure necessary for the computer's processor to execute the function according to predetermined procedure. In addition, the code may further include a memory reference-related code that indicates at which location (address address) in the computer's internal or external memory additional information or media required for the computer's processor to execute the above function should be referenced. In addition, if the computer's processor needs to communicate with any other remote computer or server in order to execute the above function, the code may further include a communication-related code regarding whether communication should be performed and what information or media should be transmitted and received during communication with any other remote computer or server using the computer's communication module.

The storage medium refers to a medium that stores data semi-permanently and may be read by a device, rather than a medium that stores data for a short period of time, such as a register, a cache, or a memory. Specifically, examples of the storage medium include ROM, RAM, CD-ROM, magnetic tape, floppy disk, optical data storage device, and the like, but are not limited thereto. That is, the program may be stored in various recording media on various servers that the computer may access or on various recording media on the user's computer. Additionally, the medium may be distributed to computer systems connected to a network, and a computer-readable code may be stored in a distributed manner.

The steps of the method or algorithm described in connection with the embodiments of the present disclosure may be implemented directly in hardware, implemented as a software module executed by hardware, or a combination thereof. The software module may reside on RAM (Random Access Memory), ROM (Read Only Memory), EPROM (Erasable Programmable ROM), EEPROM (Electrically Erasable Programmable ROM), Flash Memory, hard disk, removable disk, CD-ROM, or any type of computer-readable recording medium well known in the art to which the present disclosure pertains.

Although the embodiments of the present disclosure have been described with reference to the attached drawings, those skilled in the art will understand that the present disclosure can be implemented in other specific forms without changing its technical idea or essential features. Therefore, the embodiments described above should be understood in all respects as illustrative and not restrictive.

As described above, according to the present disclosure, a tag and a keyword are extracted from the cosmetics-related product data and the cosmetics-related social data to analyze and predict the cosmetics trend, thereby providing a main screen containing various service items to the user terminal, providing the cosmetics trend prediction information corresponding to the selection of service items of the user, and providing the cosmetics trend prediction information that reflects trends from the customer's perspective required in the market in real time in a visualized manner in various forms.

In addition, according to the present disclosure, the market responsiveness may be increased in a company's sales activities and execution, such as new product planning and marketing activities, by matching consumer needs and cosmetics characteristics.

The effects of the present disclosure are not limited to the effects mentioned above, and other effects not mentioned will be clearly understood by those skilled in the art from the description.

What is claimed is:

1. An apparatus for providing cosmetics trend prediction service comprising a user terminal and a platform server connected to an external server,
wherein the platform server includes:
a communication unit connected to the user terminal and the external server and configured to receive cosmetics-related product data and cosmetics-related social data;
a preprocessing unit configured to process the cosmetics-related product data and the cosmetics-related social data;
a tag generating unit configured to classify the processed cosmetics-related product data and cosmetics-related social data and generate a corresponding tag;
a keyword extracting unit configured to extract a keyword from the tag, the cosmetics-related product data, and the cosmetics-related social data;
a cosmetics trend prediction unit configured to analyze and predict a cosmetics trend based on the extracted keyword; and
a control unit configured to control the communication unit, the preprocessing unit, the tag generating unit, the keyword extracting unit, and the cosmetics trend prediction unit,
wherein the control unit is configured to:
based on collecting the cosmetics-related product data and the cosmetics-related social data through the communication unit, control the preprocessing unit, the tag generating unit, and the keyword extracting unit to automatically classify the collected cosmetics-related product data and the cosmetics-related social data by cosmetics categories, generate the corresponding tag, and extract the keyword, control the cosmetics trend prediction unit to analyze and predict the cosmetics trend based on the tag and keyword, based on receiving a request for cosmetics trend prediction service from the user terminal, provide the cosmetics trend prediction service to the user terminal to display a main screen including at least one service item among a cosmetics schema item, a cosmetics-related product data item, a cosmetics-related social data item, a cosmetics keyword item, a cosmetics trend analysis item, and a cosmetics trend prediction item, and based on receiving a user selection input for selecting a service item included in the main screen from the user terminal, provide corresponding cosmetics trend prediction information.

2. The apparatus of claim 1, wherein,
based on receiving the user selection input for selecting the cosmetics schema item among the service items, the control unit is configured to provide a tag tree including a plurality of main tags that firstly classify cosmetics by use, sub tags that secondly classify each main tag by color, composition, and area, and detailed tags that thirdly classify each sub-tag according to detailed information, a user selection box for each tag, and a tag add button.

3. The apparatus of claim 1, wherein,
based on receiving the user selection input for selecting the cosmetics-related product data item among the service items, the control unit is configured to provide a plurality of brand tags that firstly classify cosmetics by brand, product tags that secondly classify cosmetics products corresponding to each brand tag, a user-selected tag table, a cosmetics-related image corresponding to the user-selected tag, a keyword table corresponding to the user-selected tag, and a button to go to a relevant site.

4. The apparatus of claim 1, wherein,
based on receiving the user selection input for selecting the cosmetics-related social data item among the service items, the control unit is configured to provide a category item classifying cosmetics by category, a social media item classifying cosmetics by social media, a cosmetic type item classifying cosmetics by type, a review author item classified by review author, an input field for review author search term, a user selection box for each classification item, a cosmetics image, cosmetics detailed information of cosmetics, and a search result field including a keyword for cosmetics.

5. The apparatus of claim 1, wherein,
based on receiving the user selection input for selecting the cosmetics keyword item among the service items, the control unit is configured to provide a tag filter field for a cosmetics type selection item and a tag selection, a search word input field, and a search results field containing a main keyword, a frequency of appearance of the main keyword, and a table of co-occurrence keywords correspondence to the main keyword.

6. The apparatus of claim 1, wherein,
based on receiving the user selection input for selecting the cosmetics trend analysis item among the service items, the control unit is configured to provide a media filter item, a keyword filter item, a cosmetics type input item, a central tag input item, sub-tags corresponding to the input central tag, a user selection box for each sub-tag, related tags, a user selection box for each related tag, and a cosmetics trend visualization button.

7. The apparatus of claim 1, wherein,
based on receiving the user input for selecting the cosmetics trend visualization button, the control unit is configured to provide the cosmetics trend analysis information by visualizing a sub-tag and a related tag corresponding to the central tag in a form of a bubble or a related network.

8. The apparatus of claim 1, wherein,
based on receiving the user selection input for selecting the cosmetics trend prediction item among the service items, the control unit is configured to provide a plurality of main tag selection items that categorize cosmetics by use, a sub-tag input field for the main tag selection item, a trend makeup method input field for the input sub-tag, a palette configuration method input field for the input trend makeup method, a palette number input field for the palette configuration method, and a formulation input field for the input number of palettes.

9. A method for providing cosmetics trend prediction service, the method performed by a platform server comprising:
collecting cosmetics-related product data and cosmetics-related social data;
automatically classifying the collected cosmetics-related product data and cosmetics-related social data into cosmetics categories, generating a corresponding tag and keyword;
analyzing and predicting the cosmetics trend based on the tag and keyword;
based on receiving a request for cosmetics trend prediction service from a user terminal, providing the cosmetics trend prediction service to the user terminal to display a main screen including at least one service item among a cosmetics schema item, a cosmetics-related product data item, a cosmetics-related social data item, a cosmetics keyword item, a cosmetics trend analysis item, and a cosmetics trend prediction item, and
based on receiving a user selection input for selecting a service item included in the main screen from the user terminal, providing corresponding cosmetics trend prediction information.

10. The method of claim 9, wherein,
providing the corresponding cosmetics trend prediction information includes:
based on receiving the user selection input for selecting the cosmetics schema item among the service items, providing a tag tree including a plurality of main tags that firstly classify cosmetics by use, sub tags that secondly classify each main tag by color, composition, and area, and detailed tags that thirdly classify each sub-tag according to detailed information, a user selection box for each tag, and a tag add button.

11. The method of claim 9, wherein,
providing the corresponding cosmetics trend prediction information includes:
based on receiving the user selection input for selecting the cosmetics-related product data item among the service items, providing a plurality of brand tags that firstly classify cosmetics by brand, product tags that secondly classify cosmetics products corresponding to each brand tag, a user-selected tag table, a cosmetics-related image corresponding to the user-selected tag, a keyword table corresponding to the user-selected tag, and a button to go to a relevant site.

12. The method of claim 9, wherein,
providing the corresponding cosmetics trend prediction information includes:
based on receiving the user selection input for selecting the cosmetics-related social data item among the service items, providing a category item classifying cosmetics by category, a social media item classifying cosmetics by social media, a cosmetic type item classifying cosmetics by type, a review author item classified by review author, an input field for review author search term, a user selection box for each classification item, a cosmetics image, cosmetics detailed information of cosmetics, and a search result field including a keyword for cosmetics.

13. The method of claim 9, wherein,
providing the corresponding cosmetics trend prediction information includes:
based on receiving the user selection input for selecting the cosmetics keyword item among the service items, providing a tag filter field for a cosmetics type selection item and a tag selection, a search word input field, and a search results field containing a main keyword, a frequency of appearance of the main keyword, and a table of co-occurrence keywords correspondence to the main keyword.

14. The method of claim 9, wherein,
providing the corresponding cosmetics trend prediction information includes:
based on receiving the user selection input for selecting the cosmetics trend analysis item among the service items, providing a media filter item, a keyword filter item, a cosmetics type input item, a central tag input item, sub-tags corresponding to the input central tag, a user selection box for each sub-tag, related tags, a user selection box for each related tag, and a cosmetics trend visualization button.

15. A computer-readable recording medium in connection with a hardware computer and stores a program for executing the method of claim 9.
